(19) United States
(12) Patent Application Publication
(10) Pub. No.: US 2023/0010496 A1
(43) Pub. Date: Jan. 12, 2023

(54) VEHICLE AND CONTROL METHOD THEREOF

(71) Applicants: HYUNDAI MOTOR COMPANY, Seoul (KR); KIA CORPORATION, Seoul (KR)

(72) Inventors: Jaewoong CHOI, Seoul (KR); Jeongmin CHO, Gyeonggi-do (KR); Yonjun JANG, Gyeonggi-do (KR); Hyunsu KIM, Gyeonggi-do (KR)

(73) Assignees: Hyundai Motor Company, Seoul (KR); KIA CORPORATION, Seoul (KR)

(21) Appl. No.: 17/858,375

(22) Filed: Jul. 6, 2022

(30) Foreign Application Priority Data
Jul. 6, 2021 (KR) 10-2021-0088326

(51) Int. Cl. B60W 30/095

(52) U.S. Cl. CPC B60W 30/0956; B60W 2530/201; B60W 2510/1005; B60W 2520/06; B60W 2520/10; B60W 2520/125; B60W 2554/402; B60W 2554/4041; B60W 2554/4042; B60W 2554/4044

(57) ABSTRACT

A vehicle includes a controller that identifies a target around the vehicle and calculates a danger range of the identified target, based on processing surrounding data obtained by sensor devices; calculates a danger range of the vehicle based on processing driving data obtained by sensor devices; determines a danger of collision based on the danger range of the target and the danger range of the vehicle, and control a driving apparatus based on the determined danger of collision. Such a vehicle and a control method thereof can make it possible to avoid a collision based on a danger range by calculating the danger range between the vehicle and a surrounding object of the vehicle depending on a factor causing uneasiness of a user.

### CROSS-REFERENCE TO RELATED APPLICATION(S)

This application is based on and claims the benefit of priority to Korean Patent Application No. 10-2021-0088326, filed on Jul. 6, 2021 in the Korean Intellectual Property Office, the disclosure of which is incorporated by reference herein in its entirety.

### TECHNICAL FIELD

The disclosure relates to a vehicle for avoiding a collision based on a danger range between the vehicle and a surrounding object of the vehicle, and a control method thereof.

### BACKGROUND

Recently, various advanced driver assistance systems (ADAS) have been developed for autonomous driving for the convenience of drivers. In particular, as the autonomous driving market is expected to enter full-fledged growth from 2020, research on this is being actively conducted.

Examples of the advanced driver assistance systems mounted on vehicles include a forward collision avoidance (FCA) system, an autonomous emergency brake (AEB) system, and a driver attention warning (DAW) system.

These systems determine the risk of collision with an object in a driving situation of a vehicle, and provide collision avoidance and warning through emergency braking in the collision situation.

However, research on a conventional advanced driver assistance system (ADAS) is mainly conducted on a system for controlling a vehicle based on a physical collision depending on the sizes of the vehicle and objects around the vehicle. Therefore, such a system that controls a vehicle based on a physical collision may prevent an eventual collision between the vehicle and a surrounding object, but may not resolve uneasiness of a driver about the surrounding object, so that it is difficult to perform stable vehicle driving with high reliability of the driver.

The information disclosed in the Background section above is to aid in the understanding of the background of the present disclosure, and should not be taken as acknowledgement that this information forms any part of prior art.

### SUMMARY

It is an aspect of the disclosure to provide a vehicle capable of avoiding a collision based on a danger range by calculating the danger range between the vehicle and a surrounding object of the vehicle depending on a factor causing uneasiness of a user, and a control method thereof.

Additional aspects of the disclosure will be set forth in part in the description which follows and, in part, will be obvious from the description, or may be learned by practice of the disclosure.

In accordance with an aspect of the disclosure, a vehicle includes a first sensor device installed in the vehicle to obtain driving data of the vehicle, a second sensor device installed in the vehicle to obtain surrounding data of the vehicle, a driving apparatus configured to control a driving direction and speed of the vehicle, and a controller comprising a processor configured to process the surrounding data and the driving data, wherein the controller is configured to identify a target around the vehicle and calculate a danger range of the identified target, based on processing the surrounding data, calculate a danger range of the vehicle based on processing the driving data, determine a danger of collision based on the danger range of the target and the danger range of the vehicle, and control the driving apparatus based on the determined danger of collision.

The danger range of the target may be different from a size of the target, and the danger range of the vehicle may be different from a size of the vehicle.

The controller may be further configured to predict an expected driving path of the vehicle and an expected driving path of the target based on processing the driving data and the surrounding data, and determine the danger of collision further based on the expected driving path of the vehicle and the expected driving path of the target.

The controller may be further configured to determine reliability of the expected driving path of the vehicle based on a learning table generated by pre-learning based on the expected driving path of the vehicle and the driving data of the vehicle, determine the expected travel path of the target in response to a case where the reliability is greater than or equal to a predetermined threshold value, and control the driving apparatus such that the danger range of the vehicle and the danger range of the target do not overlap.

The danger range of the vehicle may be calculated based on at least one of a position, size, gear, driving direction, speed, or lateral acceleration of the vehicle.

The controller may be further configured to impart a weighting to at least one of the gear, speed, or lateral acceleration of the vehicle, and expand the danger range of the vehicle further based on the weighting.

The danger range of the target may be calculated based on at least one of a type, position, size, speed, or driving direction of the target.

The controller may be further configured to impart a weighting to at least one of the speed or the position depending on the type of the target, and expand the danger range of the target further based on the weighting.

The controller may be further configured to divide control actions depending on a size of an area in which the danger range of the target and the danger range of the vehicle overlap, and control the driving apparatus based on the divided control actions.

In accordance with an aspect of the disclosure, a control method of a vehicle includes obtaining driving data of the vehicle by a first sensor device installed in the vehicle, obtaining surrounding data of the vehicle by a second sensor device installed in the vehicle, identifying a target around the vehicle and calculating a danger range of the identified target, based on processing the surrounding data, calculating a danger range of the vehicle based on processing the driving data, determining a danger of collision based on the danger range of the target and the danger range of the vehicle, and controlling a driving apparatus based on the determined danger of collision.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a diagram illustrating a sequence of controlling a vehicle based on a danger range between a vehicle and a surrounding object of the vehicle according to an exemplary embodiment;

FIG. 2 is a control block diagram of the vehicle according to an exemplary embodiment;

FIGS. 3A and 3B are conceptual diagrams for comparing a vehicle collision prediction with respect to a front object according to an exemplary embodiment (FIG. 3B) and a conventional vehicle collision prediction (FIG. 3A);

FIGS. 4A and 4B are conceptual diagrams for comparing a vehicle collision prediction with respect to a side object according to an exemplary embodiment (FIG. 4B) and a conventional vehicle collision prediction (FIG. 4A);

FIGS. 5A and 5B are conceptual diagrams for comparing a vehicle collision prediction with respect to a rear object according to an exemplary embodiment (FIG. 5B) and a conventional vehicle collision prediction (FIG. 5A);

FIG. 6A is a graph for explaining a weighting based on a speed of the vehicle according to an exemplary embodiment;

FIG. 6B is a graph for explaining a weighting based on a lateral acceleration of the vehicle according to an exemplary embodiment:

FIG. 7 is a conceptual diagram for explaining calculating a danger range of the vehicle according to an exemplary embodiment;

FIG. 8A is a graph for explaining a weighting based on a type and speed of a target according to an exemplary embodiment;

FIG. 8B is a graph for explaining a weighting based on a type and speed of a target according to an exemplary embodiment;

FIG. 9 is a conceptual diagram for explaining a weighting based on a position of a target according to an exemplary embodiment;

FIG. 10 is a conceptual diagram for explaining calculating a danger range of a target according to an exemplary embodiment;

FIG. 11 is a diagram illustrating an example of an operation of determining an expected driving path of a target by giving priority to determining a driving state of the target;

FIG. 12 is a flowchart illustrating a vehicle control method according to an exemplary embodiment;

FIG. 13 is a flowchart illustrating a method of calculating the danger range of the vehicle according to an exemplary embodiment; and

FIG. 14 is a flowchart illustrating a method of calculating a danger range of a target according to an exemplary embodiment.

### DETAILED DESCRIPTION

Throughout the specification, like reference numerals refer to like elements. This specification does not describe all the elements of the embodiments, and duplicative contents between general contents or embodiments in the technical field of the disclosure will be omitted. The terms ‘part,’ ‘module,’ ‘member,’ and ‘block’ used in this specification may be embodied as software or hardware, and it is also possible for a plurality of ‘units,’ ‘modules,’ ‘members,’ and ‘blocks’ to be embodied as one component, or one ‘unit,’ module,‘member,’ and ‘block’ to include a plurality of components according to embodiments.

Throughout the specification, when a part is referred to as being “connected” to another part, it includes not only a direct connection but also an indirect connection, and the indirect connection includes connecting through a wireless network.

Also, when it is described that a part “includes” an element, it means that the element may further include other elements, not excluding the other elements unless specifically stated otherwise.

The terms ‘first,’‘second,’ etc. are used to distinguish one element from another element, and the elements are not limited by the above-mentioned terms.

The singular forms “a,” “an,” and “the” include plural referents unless the context clearly dictates otherwise.

In each step, an identification numeral is used for convenience of explanation, the identification numeral does not describe the order of the steps, and each step may be performed differently from the order specified unless the context clearly states a particular order.

Hereinafter, the disclosure will be described in detail with reference to the accompanying drawings.

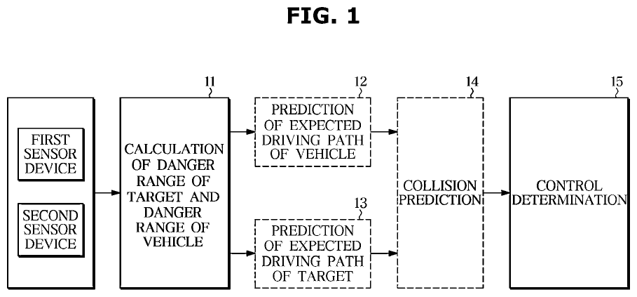

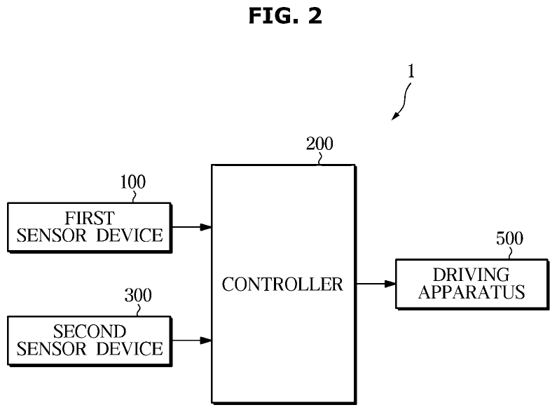

FIG. 1 is a diagram illustrating a sequence of controlling a vehicle based on a danger range between a vehicle and a surrounding object of the vehicle according to an embodiment, and FIG. 2 is a control block diagram of the vehicle according to an embodiment. Referring to FIGS. 1 and 2, a vehicle 1 may obtain, through a first sensor device 100, driving information of the vehicle 1 including size and position information of the vehicle 1, speed information of the vehicle 1, heading information of the vehicle 1, lateral acceleration information of the vehicle 1, and gear information of the vehicle 1.

A second sensor device 300 may obtain surrounding information including position information of a target, speed information of the target, size information of the target, and driving direction information of the object, and surrounding road information of the vehicle 1. Herein, the target may refer to, for example, an object existing around the vehicle 1.

The second sensor device 300 may include, for example, a front and/or rear camera installed in the vehicle 1, a front and/or rear radar sensor, and a lidar sensor.

A controller 200 may identify an object existing around the vehicle 1 based on the vehicle surrounding information. In particular, the controller 200 may identify other vehicles or pedestrians or cyclists or lanes (markers that distinguish lanes) or free space. Accordingly, the controller 200 may identify the type of the target based on the surrounding information of the vehicle 1.

The controller 200 may calculate the danger range of the vehicle 1 based on the vehicle driving information (11). The danger range of the vehicle 1 may be, for example, the area itself occupied by the vehicle 1 based on a size and position of the vehicle 1, and may be an expanded area including an area where a driver feels uneasiness based on a speed of the vehicle 1 and a lateral acceleration of the vehicle 1. However, the disclosure is not limited thereto.

Also, the controller 200 may calculate a danger range of the identified target based on the vehicle surrounding information (11). The danger range of the target may be, for example, the area itself occupied by the target based on a size and position of the target, and may be an expanded area including an area expressing the uneasiness that the driver may feel toward the target based on a speed of the target, the size of the target, and a driving direction of the target.

More specifically. the controller 200 may calculate the danger range of the vehicle 1 based on at least one of the position, size, gear, driving direction, speed, or lateral acceleration of the vehicle 1.

The controller 200 may classify control actions depending on a size of an overlapped region between the areas based on the calculated danger range of the vehicle 1 and the calculated danger range of the target, and may generate a control signal for controlling a driving apparatus 500 based on the classified control actions.

More specifically, the controller 200 may provide a warning to the driver by generating only a control signal for controlling a display device and an audio device of the driving apparatus 500 when the size of the overlapped region of the danger range of the vehicle 1 and the danger range of the target is less than a first preset value. Also, the controller 200 may generate a control signal for controlling a braking device and a driving device of the driving apparatus 500 when the size of the overlapped region is larger than or equal to the first preset value but smaller than a second preset value, thereby generating a control signal for controlling a longitudinal speed of the vehicle 1 to be equal to or smaller than a target speed of an element parallel to a longitudinal direction, Herein, the longitudinal speed may refer to a direction parallel to the driving direction of the vehicle 1. However, the disclosure is not limited thereto.

in another embodiment, the controller 200 may generate a control signal for controlling the driving apparatus 500 depending on a range of a preset value for each step. In summary, it may be understood that not only the first and second preset values but also a preset value greater than or equal to a third value may be applied.

Accordingly, the controller 200 may perform smooth control of the vehicle 1 capable of facilitating stable driving by resolving uneasiness of the driver.

The controller 200 may estimate the position of the vehicle 1 using a high-definition map (HO map), image data, radar data, and lidar data stored in a memory. For example, the controller 200 may identify distances to a plurality of landmarks on the high-definition map based on lidar data, and may identify an absolute position of the vehicle 1 based on the distances to the plurality of landmarks.

The controller 200 may also project surrounding objects of the vehicle 1 on the high-definition map based on the image data, the radar data, and the lidar data. The controller 200 may project the surrounding objects of the vehicle 1 on the high-definition map based on the absolute position of the vehicle 10 and relative positions of the objects. However, the disclosure is not limited thereto, In another embodiment, the controller 200 may project the calculated danger range of the vehicle 1 and the calculated danger range of the target to be superimposed on the high-definition map.

The controller 200 may predict an expected driving path of the vehicle 1 based on the vehicle driving information (12), determine reliability of the expected driving path of the vehicle 1 based on GPS data of the vehicle 1 and the expected driving path of the vehicle 1, determine an expected driving path of a target 2 based on target driving information when the reliability of the expected driving path of the vehicle 1 is equal to or greater than a predetermined threshold value (13), and predict a collision with the target 2 based on the expected driving path of target 2, the danger range of the vehicle 1 and the danger range of the target 2 (14). Accordingly, the controller 200 may control the driving apparatus 500 to avoid a collision (15) based on the collision prediction (14).

The driving apparatus 500 may perform a function of changing the direction of the vehicle 1 or adjusting the speed of the vehicle 1.

More specifically, the driving apparatus 500 may include, for example, the driving device, the braking device, a steering device, the display device, and the audio device. These devices may communicate with each other via the vehicle communication network NT. For example, the electric devices (drive device, brake device, steering device, display device, audio device, etc.) included in the vehicle 1 may send and receive data through Ethernet, MOST (Media Oriented Systems Transport), Flexray, CAN (Controller Area Network), LIN (Local Interconnect Network), and the like.

The driving device may move the vehicle 1 and include, for example, an engine, an engine management system (EMS), a transmission, and a transmission control unit (TCU). The engine may generate power for driving the vehicle 1, and the engine management system may control the engine in response to an acceleration intention of the driver through an accelerator pedal or a request from the controller 200. The transmission may transmit the power generated by the engine to wheels with deceleration, and the transmission control unit may control the transmission in response to a shift command of the driver through a shift lever and/or a request from the controller 200.

The braking device may stop the vehicle 1 and include, for example, a brake caliper and a brake control module (EBCM). The brake caliper may decelerate the vehicle 1 or stop the vehicle 1 by using friction with a brake disc, and the electronic brake control module may control the brake caliper in response to a braking intention of the driver through a brake pedal and/or a request of the controller 200. For example, the electronic brake control module may receive a deceleration request including deceleration from the controller 200, and may control the brake caliper electrically or hydraulically so that the vehicle 1 is decelerated depending on the requested deceleration.

The steering device may include an electronic power steering control module

(EPS). The steering device may change the driving direction of the vehicle 1, and the electronic power steering control module may assist an operation of the steering device so that the driver may easily manipulate a steering wheel in response to a steering intention of the driver through the steering wheel. Also, the electronic power steering control module may control the steering device in response to a request of the controller 200. For example, the electronic power steering control module may receive a steering request including a steering torque from the controller 200 and control the steering device to steer the vehicle 1 depending on the requested steering torque.

The display device may include a cluster, a head-up display, a center fascia monitor, and the like, and provide various information and entertainment to the driver through images and sounds. For example, the display device may provide driving information of the vehicle 1, route information to a destination, and a warning message to the driver. Also, the display device may provide a high-definition map projected on the basis of the danger range of the vehicle 1 and the danger range of the target calculated by the controller 200.

The audio device may include a plurality of speakers, so that various information and entertainment may be provided to the driver through sound. For example, the audio device may provide driving information of the vehicle 1, route information to a destination, and a warning message to the driver.

Specifically, the controller 200 may determine an absolute speed of the target based on the vehicle driving information and surrounding information. The absolute speed of the target may be obtained by correcting a predetermined value based on a relative speed of the target, the vehicle driving information and the position of the target included in the surrounding information of the vehicle 1, rather than the relative speed of the target. The reliability of the expected driving path of the vehicle 1 may be determined based on the GPS data of the vehicle 1 and the expected driving path of the vehicle 1. Specifically, by generating a reliability table based on the GPS data of vehicle 1 and an error of the expected driving path of vehicle 1 and inserting the generated reliability table into logic, reliability according to the corresponding signal in vehicle 1 may be derived at all times.

First, a reliability learning reference signal is defined (Input), a reference signal learning section is divided, and a section according to the input signal is arbitrarily learned. After that, an average of error accumulation is updated to generate a reliability table. In this case, the average of error accumulation is learned based on measurement data, and the reliability table may be selected according to the input signal. At this time, the reliability of the expected driving path of a vehicle is determined based on a learning table generated by pre-learning based on an expected driving path and GPS data of the vehicle and an internal signal of the vehicle.

When the reliability table is formed, the reliability is derived in real time based on the reliability table. The reliability of the expected driving path determined in real time is compared with the predetermined threshold value, and when the reliability of the expected driving path of the vehicle is greater than or equal to the predetermined threshold value, the expected driving path of the target is predicted in real time based on the target driving information (12). Herein, the threshold value may vary depending on a driving state of the target. In determining the driving state of the target, the state in which an offset from the left (Lh) or right (Rh) lane of the information on opposite side lanes of the vehicle 1 to the target is maintained constant is determined as a first state, a state in which the driving direction of the target is maintained is determined as a second state, a state in which an offset between the expected driving path of the vehicle 1 and the target is maintained is determined as a third state, a state in which the target is stopped is determined as a fourth state, and a state in which the target drives linearly is determined as a fifth state. A minimum value required to determine each driving state may be determined as each threshold value. The offset may represent a distance to be measured.

When a reliability value of the vehicle 1 is lower than the threshold value, for example, when the direction of the vehicle 1 is changed more frequently than usual and the driving of the vehicle 1 is irregular, the expected driving path may not be predicted properly, and thus may be determined as having a low reliability. In this case, the controller 200 may generate a control signal for controlling the driving apparatus 500 depending on a degree to which the danger ranges of the vehicle 1 and the target overlap based on the danger range of the vehicle 1 and the danger range of the target.

The reliability of the expected driving path of the vehicle 1 that is equal to or greater than the threshold value may mean that the expected driving path of the vehicle 1 is predictable.

The controller 200 may predict the expected driving path of the target 2 in real time (12) and then predict the expected driving path of the target 2, and predict a collision between the vehicle 1 and the target 2 based on the expected driving path of the vehicle 1 and the expected driving path of the target 2 (14), thereby controlling the driving apparatus 500 to avoid a collision (15).

The controller 200 may be implemented as a memory (not shown) for storing an algorithm for controlling the operations of components or data for a program reproducing the algorithm and a processor (not shown), e.g., computer, microprocessor, CPU, ASIC, circuitry, logic circuits, etc., for performing the above-described operations using data stored in the memory. In this case, the memory may be implemented as a separate chip from the processor or may be implemented as a single chip with the processor.

At least one component may be added or removed depending on the performance of the components of the system illustrated in FIGS. 1 and 2. In addition, it will be readily understood by those of ordinary skill in the art that the mutual positions of the components may be changed depending on the performance or structure of the system.

Each component illustrated in FIGS. 1 and 2 refers to a software and/or hardware component such as a field programmable gate array (FPGA) and an application specific integrated circuit (ASIC).

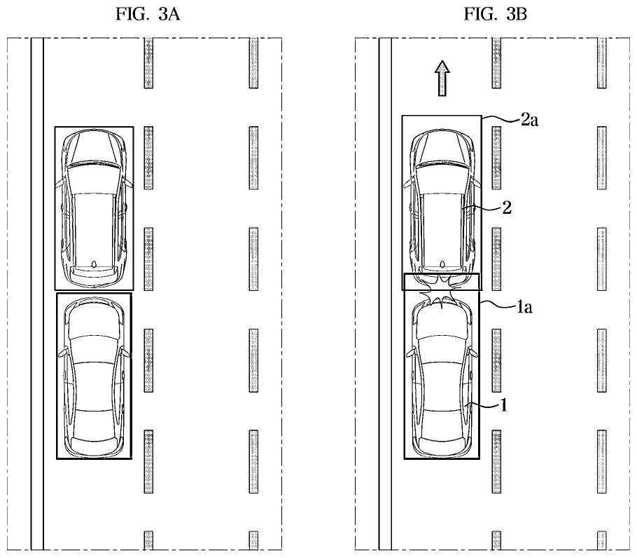

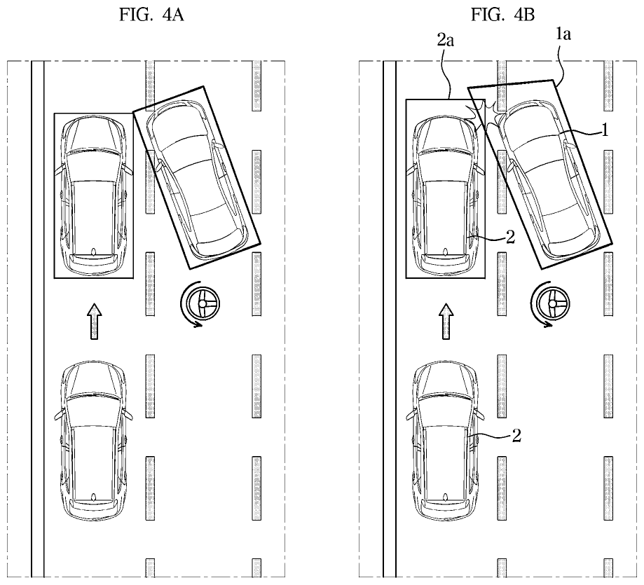

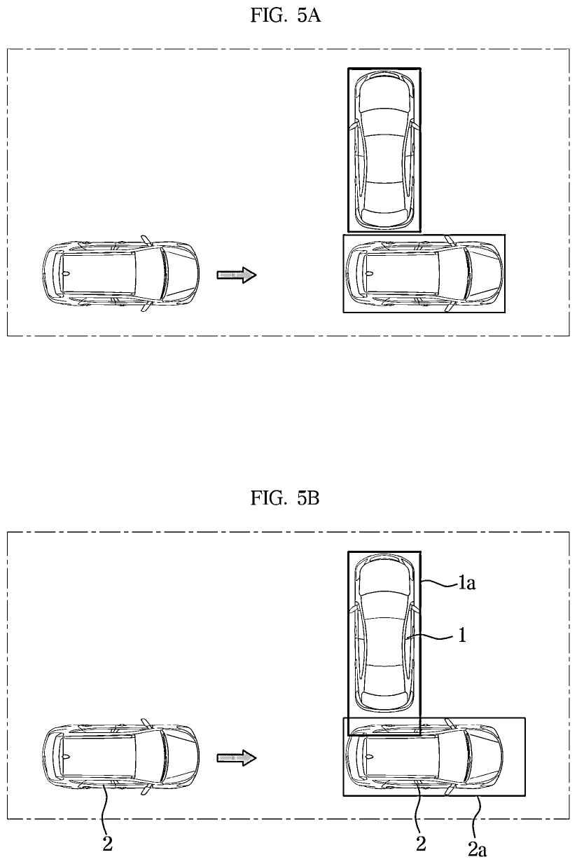

FIGS. 3A and 3B are conceptual diagrams for comparing a vehicle collision prediction with respect to a front object according to an embodiment and a conventional vehicle collision prediction, FIGS. 4A and 4B are conceptual diagrams for comparing a vehicle collision prediction with respect to a side object according to an embodiment and a conventional vehicle collision prediction, and FIGS. 5A and 5B are conceptual diagrams for comparing a vehicle collision prediction with respect to a rear object according to an embodiment and a conventional vehicle collision prediction.

Referring to FIGS. 3A, 4B and 5B, because a vehicle equipped with a conventional driver assistance system determines a collision based on prediction of a physical collision or physical contact, the vehicle may ultimately provide an effect of avoiding a collision between the vehicle and surrounding objects, but a situation in which the driver may have uneasiness may occur. The vehicle 1 according to the embodiment of the disclosure may aim to provide stable vehicle driving by resolving such uneasiness. That is, the vehicle 1 did not collide, but expresses the danger felt by the driver by the target existing in the vicinity and controls a vehicle body.

Referring to FIGS. 3B, 4B and 5B, the controller 200 according to an embodiment of the disclosure may calculate a danger range 1a of the vehicle 1 and a danger range 2a of the target 2 and determine the danger of collision based on the danger ranges 1a and 2a, Accordingly, the controller 200 may control the driving apparatus 500 based on the determined danger of collision.

More specifically, the driver tends to maintain a long safety distance in high-speed driving. Even in a situation where target 2 and vehicle 1 which drive at high speed do not physically collide, the driver feels the danger and expects the driving safety system to intervene and perform a notification or control. As illustrated in FIG. 3B, the controller 200 may expand and calculate the danger range 1a of the vehicle 1 in the driving direction of the vehicle 1 in proportion to the speed of the vehicle 1, Accordingly, the controller 200 may determine the danger of collision similar to that felt by the driver, and may control the driving apparatus 500 based on the determination of the danger of collision.

Also, the driver tends to secure a long safety distance with respect to the target 2 approaching from the rear of a turning direction when the vehicle 1 turns. That is, the driver may feel the danger even in a situation where a physical collision does not occur. As illustrated in FIG. 4B, the controller 200 may expand and calculate the danger range 1a in proportion to a lateral acceleration generated based on a rotation angle of the steering wheel of the vehicle 1.

Also, a degree to which the driver feels a danger may be different depending on the position of the vehicle 1 and the position of the target 2, For example, when the position of the target 2 corresponds to a blind spot of the vehicle 1, a danger that the driver feels for the target 2 may increase, and when the target 2 is located in a position within a visible range of the driver, a danger that the driver feels may relatively decrease. Accordingly, the controller 200 may expand and calculate the danger range 2a of the target 2 in the driving direction of the target 2 depending on the position of target 2 with respect to a relative position of vehicle 1.

Also, when the vehicle 1 reverses, the driver feels a great danger with respect to the target 2 approaching from a rear side of the vehicle 1. As illustrated in FIG. 5B, the controller 200 may expand and calculate the danger range 1a of the vehicle 1 in the driving direction of the vehicle 1 depending on the driving direction of the vehicle 1. In other words, the controller 200 may expand and calculate the danger range 1a of the vehicle 1 depending on the gear of the vehicle 1.

Hereinafter, the danger ranges 1a and 2a calculated by he controller 200 of the vehicle 1 will be described in more detail.

The controller 200 may calculate the danger rangel a of the vehicle 1 based on processing of the driving data of the vehicle 1 obtained by the first sensor device 100. More specifically, the controller 200 may calculate the danger range based on at least one of the position, size, gear, driving direction, or lateral acceleration of the vehicle 1 included in the driving data. The controller 200 may also impart a weighting to at least one of the gear, speed, or lateral acceleration of the vehicle 1 and may expand and calculate the danger range 1a of the vehicle 1 based on the weighting.

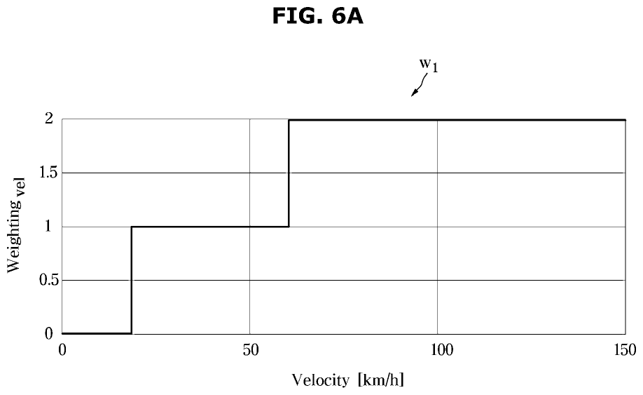

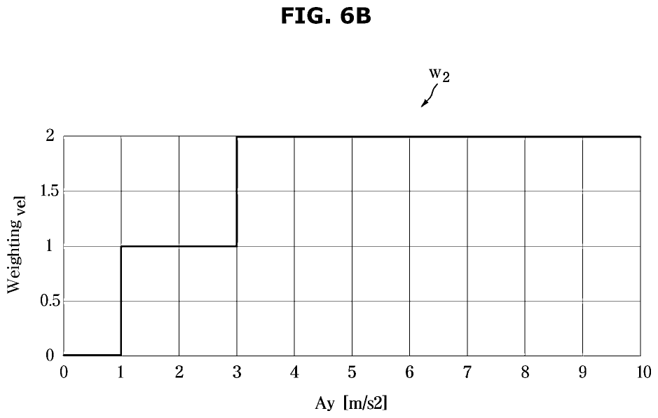

FIG. 6A is a graph for explaining a weighting based on a speed of the vehicle according to an embodiment.

Referring to FIG. 6A, the controller 200 may obtain the position, size, gear, driving direction, speed, and lateral acceleration of the vehicle 1 based on the processing of the driving data of the vehicle 1 obtained by the first sensor device 100. Accordingly, the controller 200 may calculate the danger range la of the vehicle 1 based on at least one of the position, size, gear, driving direction, speed, or lateral acceleration of the vehicle 1.

For example, a weighting may be imparted to at least one of the gear, speed or lateral acceleration of the vehicle 1, and the danger range 1a of the vehicle 1 to be calculated by the controller 200 may be expanded, further based on the weighting. As described above, this may be to reflect a weighting in the danger range la of the vehicle 1 based on a degree of danger that the driver feels depending on the gear of the vehicle 1 (the driving direction of the vehicle 1), a degree of dandier that the driver feels depending on the speed of the vehicle 1, and a degree of danger that the driver feels depending on the turning of the vehicle 1. Herein, it may be understood that the weighting may be variably applied depending on uneasiness of the driver. Accordingly, a numerical value of the weighting, which will be described below, may be easily changed by a person skilled in the art, and may be calculated empirically or experimentally, set separately by the driver, or changed depending on driving habits of the driver.

As illustrated in FIG. 6A, the controller 200 may impart a weighting w1 depending on the speed of the vehicle 1. More specifically, because in a first speed section (less than 20 km/h) used during parking, a degree to which the driver feels a danger with respect to the target 2 existing in the vicinity of the vehicle 1 is very low, the controller 200 may impart the weighting w1 as 0 when the speed of the vehicle 1 corresponds to the first speed section.

Because in a second speed section (20 km/h or more and less than 60 km/h) corresponding to the driving speed of the vehicle 1 in a normal city, the degree to which the driver feels a danger with respect to the target 2 existing in the vicinity of the vehicle 1 is relatively high compared to the first speed section, the controller 200 may impart the weighting wl as 1 when the speed of the vehicle 1 corresponds to the second speed section. Also, the controller 200 may impart the weighting w1 as 2 when the speed of the vehicle 1 is in a third speed section (60 km/h or more). As illustrated in FIG. 6A, for convenience of description, a speed range is divided into the first speed section, the second speed section, and the third speed section, but is not limited thereto. That is, the speed range may be changed depending on the convenience of the user and design. Therefore, because the weighting may be subdivided depending on the range, it may be more preferable that the weighting depending on the speed section is applied linearly depending on the speed.

FIG. 6B is a graph for explaining a weighting based on a lateral acceleration of the vehicle according to an embodiment.

As illustrated in FIG. 6B, the controller 200 may impart a weighting w2 depending on the lateral acceleration of the vehicle 1. More specifically, when the driver turns the driving direction of the vehicle 1, by reflecting the danger felt by the driver with respect to the target 2 existing in the vicinity of the vehicle 1, the weighting w2 may be imparted based on the lateral acceleration of the vehicle 1 that occurs as the driver controls the steering wheel of the vehicle 1. The lateral acceleration of the vehicle 1 may be calculated based on, for example, an acceleration sensor included in the first sensor device 100 or the speed of the vehicle 1 and the rotation angle of the steering wheel. However, the disclosure is not limited thereto.

More specifically, as illustrated in FIG. 6B, because uneasiness of the driver increases as a magnitude of the lateral acceleration generated by turning of the driver increases, the controller 200 may impart the weighting w2 as 0 when the lateral acceleration is in a first lateral acceleration section (less than 1 m/s2), may impart the weighting w2 as 1 when the lateral acceleration is in a second lateral acceleration section (1 m/s2 or more and less than 3 m/s2), and may impart the weighting w2 as 2 when the lateral acceleration is in a third lateral acceleration section (3m/s2 or more). However, the disclosure is not limited thereto. The sections divided depending on the magnitude of the lateral acceleration illustrated in FIG. 6B are divided sections for convenience of explanation, and a person skilled in the art may understand that the sections may be further divided or applied linearly depending on the magnitude of the lateral acceleration.

The controller 200 of the vehicle 1 according to an embodiment of the disclosure may change, depending on the gear of the vehicle 1, a size of the weighting wl depending on the speed of the vehicle 1 and a size of the weighting w2 depending on the lateral acceleration of the vehicle 1. The gear of the vehicle 1 may refer to, for example, the driving direction of the vehicle 1. That is, the controller 200 may change the weightings w1 and w2 depending on whether the driving direction of the vehicle 1 directs to the front of the vehicle 1 or to the rear of the vehicle 1.

More specifically, because a reverse driving of the vehicle 1 limits the visible area or is unfamiliar to the driver, when the gear of the vehicle 1 is in a reverse driving state, the controller 200 may change the weightings w1 and w2 to be greater than when the gear of the vehicle 1 is in a forward driving state depending on the above-described weighting imparting method. For example, when the gear of the vehicle 1 is in the reverse driving state, the controller 200 may multiply the weightings w1 and w2 in the forward driving state by a predetermined constant. However, the disclosure is not limited thereto.

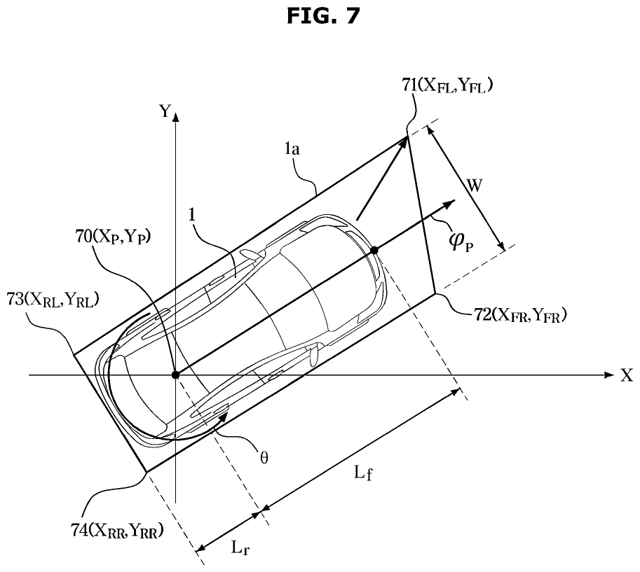

FIG. 7 is a conceptual diagram for explaining calculating a danger range of the vehicle according to an embodiment.

The controller 200 may identify the danger range of the vehicle 1 based on a position 70, a size (W, LI, Lr) and a driving direction of the vehicle 1 Information on the size of the vehicle 1 may include, for example, a width w1 of the vehicle 1, a distance Lf between the center of a rear axle and a front jumper, and a distance Lr between the center of the rear axle and a rear bumper. More specifically, the identification of coordinates of the front left and right and rear left and right sides of the vehicle 1 by the controller 200 may be derived through Equations 1 to 4 below. That is, Equation 1 may calculate the coordinates for the front left side of the danger range 1a of the vehicle 1, Equation 2 may calculate the coordinates for the front right side of the danger range 1a of the vehicle 1, Equation 3 may calculate the coordinates for the rear left side of the danger range 1a of the vehicle 1, and Equation 4 may calculate the coordinates for the rear right side of the danger range 1a of the vehicle 1.

$$( {X}_{FL} , {Y}_{FL} ) = ( {X}_{p} + {L}_{f} \cdot cos ( {ψ}_{p} ) - \frac{W}{2} \cdot sin ( {ψ}_{p} ) , {Y}_{p} + {L}_{f} \cdot sin ( {ψ}_{p} ) + \frac{W}{2} \cdot cos ( {ψ}_{p} ) ) \qquad [ Equation 1 ]$$

$$( {X}_{FR} , {Y}_{FR} ) = ( {X}_{p} + {L}_{f} \cdot cos ( {ψ}_{p} ) + \frac{W}{2} \cdot sin ( {ψ}_{p} ) , {Y}_{p} + {L}_{f} \cdot sin ( {ψ}_{p} ) - \frac{W}{2} \cdot cos ( {ψ}_{p} ) ) \qquad [ Equation 2 ]$$

$$( {X}_{RL} , {Y}_{RL} ) = ( {X}_{p} - {L}_{r} \cdot cos ( {ψ}_{p} ) - \frac{W}{2} \cdot sin ( {ψ}_{p} ) , {Y}_{p} - {L}_{r} \cdot sin ( {ψ}_{p} ) + \frac{W}{2} \cdot cos ( {ψ}_{p} ) ) \qquad Equation 3$$

$$( {X}_{RR} , {Y}_{RR} ) = ( {X}_{p} - {L}_{r} \cdot cos ( {ψ}_{p} ) + \frac{W}{2} \cdot sin ( {ψ}_{p} ) , {Y}_{p} - {L}_{r} \cdot sin ( {ψ}_{p} ) - \frac{W}{2} \cdot cos ( {ψ}_{p} ) ) \qquad Equation 4$$

Herein, Xp may represent an X component of the position 70 of the vehicle 1, and Yp may represent a Y component of the position 70 of the vehicle 1. According to the above-described equations, the danger range by the coordinates may be calculated as, for example, an area equal to or similar to a size area of the vehicle 1.

Referring to FIG. 7, the controller 200 may calculate a lateral acceleration P of the vehicle 1 based on an angle θ at which the driver rotates the steering wheel of the vehicle 1 and the lateral acceleration of the vehicle 1 obtained from the first sensor device 100 of the vehicle 1. More specifically, the lateral acceleration P of the vehicle 1 may be calculated based on the angle of the steering wheel rotated by the driver or may be the lateral acceleration obtained by the first sensor device 100 of the vehicle 1, and may also be calculated through an average value of the angle of the steering wheel and the lateral acceleration obtained by the first sensor device 100. However, the disclosure is not limited thereto.

As illustrated in FIG. 7, the controller 200 may impart the weightings w1 and w2 to at least one of a speed Vs, the gear, or the lateral acceleration of the vehicle 1 and may expand the danger range 1a of the vehicle 1 based on the weightings wi and w2. Equations 5 and 6 below are equations for calculating front coordinates 71 and 72 of the danger range 1a, for example, when the lateral acceleration occurs to the left, which is when the driver turns the steering wheel counterclockwise, and the driving direction directs to the front.

$$( \begin{matrix}{X}_{FL} \\ {Y}_{FL}\end{matrix} ) = ( \begin{matrix}\begin{matrix}{X}_{p} + ( {L}_{f} + {w}_{1} \cdot {v}_{s} ) \cdot cos ( {ψ}_{p} ) - \frac{W}{2} \cdot sin ( {ψ}_{p} ) + \\ w \text{?} \cdot v \text{?} \cdot ρ \cdot cos ( {ψ}_{p} + {v}_{s} \cdot ρ \cdot Δ t )\end{matrix} \\ \begin{matrix}{Y}_{p} + ( L \text{?} + w \text{?} \cdot v \text{?} ) \cdot sin ( {ψ}_{p} ) + \frac{W}{2} \cdot cos ( {ψ}_{p} ) + \\ w \text{?} \cdot v \text{?} \cdot ρ \cdot sin ( ψ \text{?} + v \text{?} \cdot ρ \cdot Δ t )\end{matrix}\end{matrix} ) \qquad [ Equation 5 ]$$

$$( \begin{matrix}{X}_{FR} \\ {Y}_{FR}\end{matrix} ) = ( \begin{matrix}{X}_{p} + ( {L}_{f} + w \text{?} \cdot v \text{?} ) \cdot cos ( {ψ}_{p} ) + \frac{W}{2} \cdot sin ( {ψ}_{p} ) \\ {Y}_{p} + ( {L}_{f} + w \text{?} \cdot v \text{?} ) \cdot sin ( {ψ}_{p} ) - \frac{W}{2} \cdot cos ( {ψ}_{p} )\end{matrix} ) \qquad [ Equation 6 ]$$

$$\text{?} \text{indicates text missing or illegible when filed}$$

Herein, P may represent the lateral acceleration of the vehicle 1, Vs may represent the speed of vehicle 1, and Δt may represent a time for the danger range 1a of the vehicle 1 to be predicted in the future.

That is, referring to Equations 5 and 6, when the vehicle 1 travels in a forward direction (gear in Drive), the controller 200 may impart the weighting w1 according to the speed Vs of the vehicle 1 with respect to the front coordinates 71 and 72, and may expand the danger range 1a based on the weighting w1 and the speed Vs of the vehicle 1. Accordingly, the danger range 1a of the vehicle 1 may secure a wider area forward than the size area of the vehicle 1.

Also, referring to Equation 5, when the vehicle 1 travels in the forward direction (gear in Drive) and turns to the left, the controller 200 may impart the weighting w2 according to the lateral acceleration P of the vehicle 1 with respect to the front coordinates 71 in the turning direction, and may expand the danger range 1 a based on the weighting w2 and the speed Vs of the vehicle 1. It may be understood that when the vehicle 1 turns to the right, the above may be equally applied to the front coordinates 72 in the turning direction.

Accordingly, as illustrated in FIG. 7, by expanding the danger range 1a based on the gear, speed Vs, and lateral acceleration ρ of the vehicle 1, the controller 200 may determine the danger of collision based on the expanded danger range 1 a, and thus may support a stable driving of the vehicle 1 by the driver.

For convenience of explanation, the disclosure exemplifies that the gear of the vehicle 1 is in the forward driving state (Drive) and the controller 200 calculates the danger range 1a based on the left turn. Accordingly, it may be understood that when the gear of the vehicle 1 is in the rearward driving state (Reverse), the weightings applied to the front coordinates 71 and 72 (expressed in red in Equation 6) may be applied to the rear coordinates 73 and 74. In addition, as described above, because the rearward driving (Reverse) is more likely to cause driver uneasiness than the forward driving (Drive), a value larger than the weightings w1 and w2 applied in the forward driving (Drive) may be applied in the rearward driving (Reverse). However, the disclosure is not limited thereto.

In addition, for convenience of explanation, the disclosure exemplifies that the controller 200 calculates the danger range 1a based on the case in which the vehicle 1 turns to the left. Therefore, it may be understood that the expansion of the danger range 1a based on the lateral acceleration and speed as shown in Equation 5 when the vehicle 1 turns to the right may be equally applied to the case of calculating the front right coordinates 72.

As an example, when the vehicle 1 travels rearward (Reverse) and turns to the right to generate the right lateral acceleration P , the controller 200 may calculate such that the expansion of the danger range 1a as shown in Equation 5 occurs with respect to the rear right coordinates 74 of the vehicle 1.

The information about the X and Y components is projected by the controller 200 based on the position 70 of the vehicle 1 on the high-definition map, and each of the components may be expressed by moving in parallel, but is not limited thereto.

That is, the position 70 of the vehicle 1 may be set and expressed as an origin (0,0). In addition, the coordinates for the target 2, which will be described later, are also not limited thereto.

The controller 200 may identify the target 2 that is an object existing in the vicinity of the vehicle 1 based on the processing of the surrounding data of the vehicle 1 obtained by the second sensor device 300. More specifically, the controller 200 may identify another vehicle, a pedestrian, a cyclist, a lane (a marker for distinguishing a lane), or a free space. Accordingly, the controller 200 may identify the type of the target 2 based on the surrounding information of the vehicle 1.

The controller 200 may calculate the danger range 2a of the identified target 2. More specifically, the controller 200 may calculate the danger range 2a based on at least one of the type, position, size, speed, or driving direction of the target 2 included in the surrounding data. Also, the controller 200 may impart a weighting to at least one of the speed or the position depending on the type of the target 2, and may calculate to expand the danger range 2a of the target 2 based on the weighting.

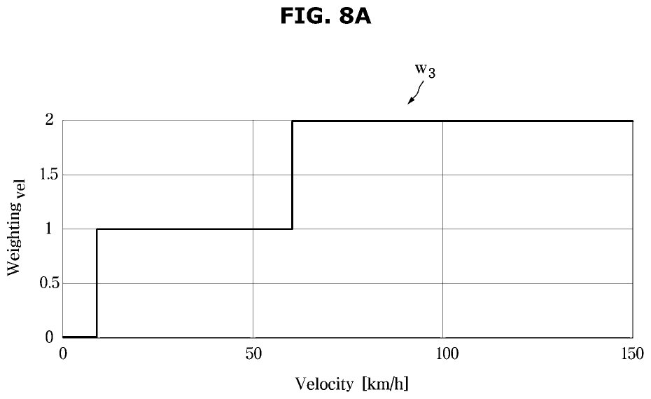

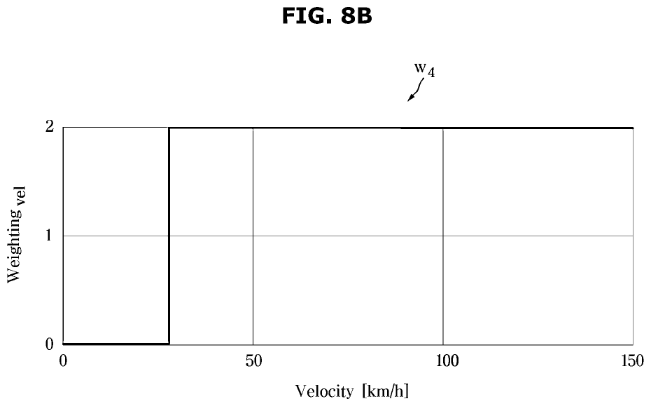

FIGS. 8A and 8B are graphs for explaining a weighting based on the type and speed of a target according to an embodiment.

As illustrated in FIGS. 8A and 8B, the controller 200 may assign a weighting w3 based on the type of target 2. More specifically, the target 2 may be classified into, for example, a vehicle/PTW and a pedestrian/cyclist. Accordingly, when the target 2 is the vehicle/PTV, as illustrated in FIG. 8A, because a degree of feeling a danger for the target 2 is very low in the first speed section (less than 20 km/h) which is difficult to distinguish from the stop of the target 2, the controller 200 may impart the weighting w3 as 0 when the speed of the target 2 corresponds to the first speed section.

Because the degree of feeling a danger for the target 2 existing in the vicinity of the vehicle 1 is relatively high compared to the first speed section in the second speed section (20 km/h or more and less than 60 km/h) corresponding to a general city driving speed of the target 2, the controller 200 may impart the weighting w3 as 1 when the speed of the target 2 corresponds to the second speed section. Also, the controller 200 may impart the weighting as 2 when the speed of the target 2 is in the third speed section (60 km/h or more).

As illustrated in FIG. 8B, because the speed of target 2 may be slightly slow when the target 2 is the pedestrian/cyclist, the controller 200 may impart a weighting based on the speed of the vehicle 1. More specifically, when the target 2 is the pedestrian/cyclist, the controller 200 may impart the weighting w3 as 1 when the speed of the target 2 is in the first speed section (less than 30 km/h), which is the general city driving speed. Also, the controller 200 may impart the weighting w3 as 2 when the speed of the target 2 is in the second speed section (30 km/h or more). However, the disclosure is not limited thereto.

As another embodiment, when target 2 is a pedestrian/cyclist, as described above, the controller 200 may impart the weighting w3 depending on a magnitude of the speed based on the speed of the target 2. That is, it may be understood that, depending on the speed section of the target 2, the faster the speed of the target 2, the larger the weighting w3 to be imparted may be imparted.

As illustrated in FIGS. 8A and 8B, for convenience of explanation, the speed section is divided into the first speed section, the second speed section and the third speed section, or the first speed section and the second speed section, but is not limited thereto. That is, the speed section may be changeable in design for the convenience of the user. Therefore, because the weighting depending on the section may be subdivided, it may be more appropriate for weighting depending on the speed section to be applied linearly depending on the speed.

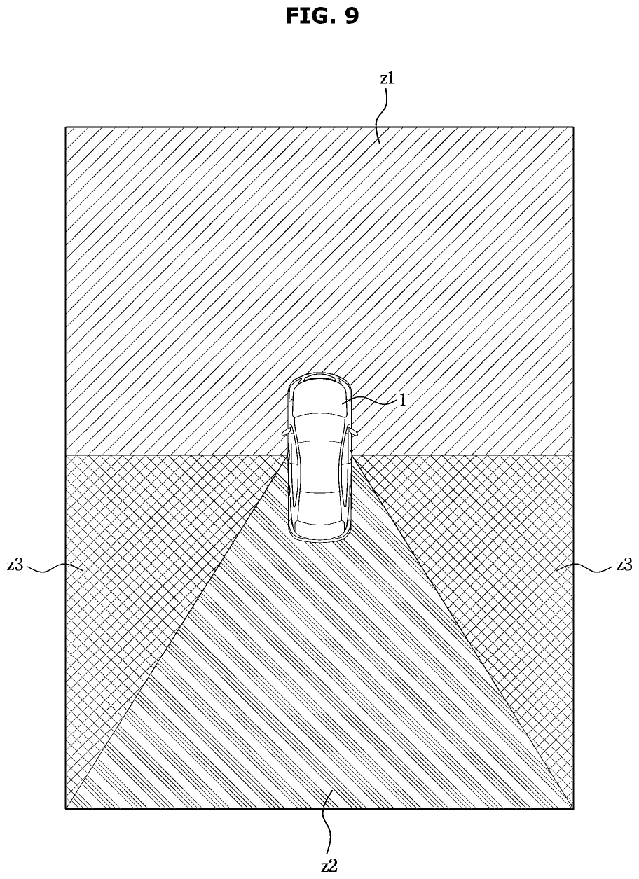

FIG. 9 is a conceptual diagram for explaining a weighting based on a position of a target according to an embodiment.

Referring to FIG. 9, the controller 200 of the vehicle 1 according to an embodiment of the disclosure may impart a weighting w4 based on the position of the target 2. More specifically, as illustrated in FIG. 9, the driver may have easy access to a view of the front of the vehicle 1. Because the driver is highly likely to feel uneasiness in the movement of target 2 that is not visible in the field of view, the controller 200 may impart the weighting w4 differently depending on the position of the target 2 based on the vehicle 1.

The position of the target 2 may be divided into a region z1 directly visible to the driver, a region z2 visible to the driver only through a mirror, and a region z3 invisible to the driver in a normal driving situation, based on the vehicle 1. Accordingly, the controller 200 may identify the position of the target 2 based on the surrounding data of the vehicle 1 obtained by the second sensor device 300, and may divide the regions z1, z2, and z3 based on the identified position. However, the disclosure is not limited thereto.

More specifically, the region z1 directly visible to the driver may correspond to a region in which a Y coordinate of the target 2 is larger than a Y coordinate of the driver's seat position based on the position of the driver's seat of the vehicle 1. The region z2 visible to the driver only through a mirror may correspond to a region in which the Y coordinate of the target 2 is smaller than the Y coordinate of the driver's seat position, and may correspond to a region in which an absolute value of the Y coordinate of the target 2 is smaller than a value obtained by multiplying an X coordinate of the target 2 by a tuning parameter a and adding b. In addition, the region z3 invisible to the driver in a normal driving situation may correspond to a region in which the Y coordinate of the target 2 is smaller than the Y coordinate of the driver's seat position, and may correspond to a region in which the absolute value of the Y coordinate of the target 2 is larger than the value obtained by multiplying the X coordinate of the target 2 by the tuning parameter a and adding b. The above-described regions z1, z2, and z3 may be determined by the controller 200 through Equations 7 to 9 below.

T_{y}≥V_{y} [Equation 7]

T_{y}<V_{y}, |T_{y}|≤Tₓ×a+b [Equation 8]

T_{y}<V_{y}, |T_{y}|>Tₓ×a+b [Equation 9]

Herein, the position of the target 2 may be expressed as (Tx, Ty), and the position of the driver's seat of the vehicle 1 may be understood as (Vx, Vy). In addition, a and b may be understood as tuning parameters according to the specifications of the vehicle 1. Herein, for example, a lateral direction in FIG. 9 may be understood as an X-axis, and a longitudinal direction in FIG. 9 may be understood as a Y-axis.

As an example, as illustrated in FIG. 9, when the position of the target 2 corresponds to the region z1 directly visible to the driver of the vehicle 1, the controller 200 may impart the weighting w4 by multiplying the weighting w3 calculated previously by 1 based on the type and speed of the target 2. That is, when it is determined that the target 2 exists in the driver's field of view, the controller 200 may apply the weighting w3 itself to the final weighting w4.

As illustrated in FIG. 9, when the position of the target 2 corresponds to the region z2 visible to the driver only through a side mirror and/or rearview mirror, the controller 200 may impart the weighting w4 by multiplying the weighting w3 calculated previously by 1.1 based on the type and speed of the target 2. Also, when the position of the target 2 corresponds to the region z3 invisible to the driver in a normal driving situation, the controller 200 may impart the final weighting w4 by multiplying the weighting w3 by 1.2. However, the disclosure is not limited thereto. Therefore, it may be understood that the above-described method of calculating the final weighting w4 may be changed.

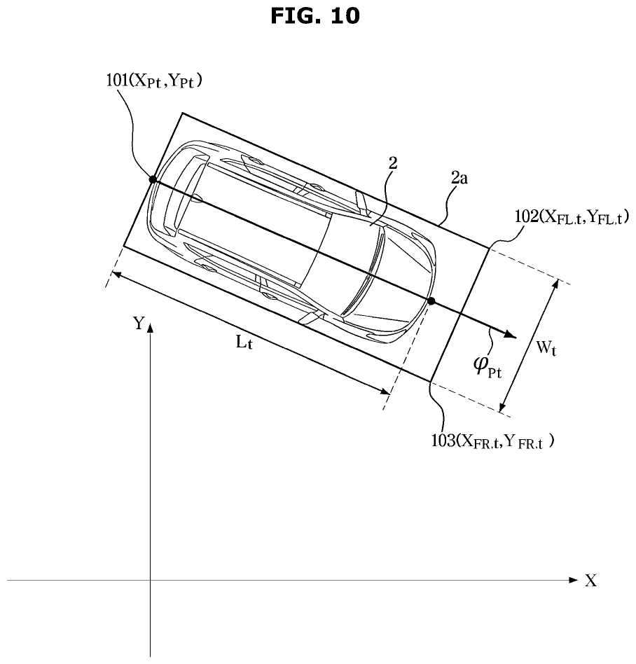

FIG. 10 is a conceptual diagram for explaining calculating a danger range of a target according to an embodiment.

The controller 200 may identify the danger range of the target 2 based on a position 101, a size (Wt, L) and a driving direction of the target 2. Information about the size of the target 2 may include, for example, the width Wt of the target 2 and a distance Lt between the center of a rear axle and a front jumper. More specifically, the identification of the coordinates of front left and right sides, and rear left and right sides of the target 2 by the controller 200 may be derived through Equations 10 to 13 below. That is, Equation 10 may calculate the coordinates for the front left side of the danger range 2a of the target 2, Equation 11 may calculate the coordinates for the front right side of the danger range 2a of the target 2, Equation 12 may calculate the coordinates for the rear left side of the danger range 2a of the target 2, and Equation 13 may calculate the coordinates for the rear left side of the danger range 2a of the target 2.

$$( {X}_{FL} \text{?} , {Y}_{FL} \text{?} ) = ( {X}_{p t} + ( L ) \cdot cos ( {ψ}_{p t} ) - \frac{{W}_{t}}{2} \cdot sin ( {ψ}_{p t} ) , \\ {Y}_{p t} + ( L ) \cdot sin ( {ψ}_{p t} ) + \frac{{W}_{t}}{2} \cdot cos ( {ψ}_{p t} ) ) \qquad [ Equation 10 ]$$

$$( {X}_{FR} \text{?} , Y \text{?} ) = ( {X}_{p t} + ( L ) \cdot cos ( {ψ}_{p t} ) + \frac{{W}_{t}}{2} \cdot sin ( {ψ}_{p t} ) , \\ {Y}_{p t} + ( L ) \cdot sin ( {ψ}_{p t} ) - \frac{{W}_{t}}{2} \cdot cos ( {ψ}_{p t} ) ) \qquad [ Equation 11 ]$$

$$( X \text{?} , Y \text{?} ) = ( {X}_{p t} - \frac{{W}_{t}}{2} \cdot sin ( {ψ}_{p t} ) , \\ {Y}_{p t} + \frac{{W}_{t}}{2} \cdot cos ( {ψ}_{p t} ) ) \qquad [ Equation 12 ]$$

$$( {X}_{RR} \text{?} , {Y}_{RR} \text{?} ) = ( {X}_{p t} + \frac{{W}_{t}}{2} \cdot sin ( {ψ}_{p t} ) , \\ {Y}_{p t} - \frac{{W}_{t}}{2} \cdot cos ( {ψ}_{p t} ) ) \qquad [ Equation 13 ]$$

$$\text{?} \text{indicates text missing or illegible when filed}$$

Herein, Xpt may mean an X component of the position 101 of the target 2, and Ypt may mean a Y component of the position 101 of the target 2, According to the above-mentioned equations, the danger range by the coordinates may be calculated as, for example, an area equal to or similar to the size area of the target 2.

Referring to FIG. 10, the controller 200 may apply the weightings w3 and w4 to at least one of a speed Vt or the position 101 of the target 2, and may expand the danger range 2a of the target 2 based on the weightings w3 and w4. Equations 14 and 15 below are, for example, equations for imparting the weightings w3 and w4 depending on the type of the target 2 based on the speed and position of the target 2 and calculating front coordinates 102 and 103 of the danger range 2a based on the weightings.

$$( \begin{matrix}{X}_{FL} \text{?} \\ {Y}_{FL} \text{?}\end{matrix} ) = ( \begin{matrix}{X}_{p t} + ( L + \text{?} \cdot v \text{?} \cdot L ) \cdot cos ( ψ \text{?} ) - \frac{{W}_{t}}{2} \cdot sin ( ψ \text{?} ) \\ Y \text{?} + ( L + \text{?} \cdot v \text{?} \cdot L ) \cdot sin ( {ψ}_{p t} ) + \frac{{W}_{t}}{2} \cdot cos ( ψ \text{?} )\end{matrix} ) \qquad [ Equation 14 ]$$

$$( \begin{matrix}{X}_{FR ,} \text{?} \\ {Y}_{FR ,} \text{?}\end{matrix} ) = ( \begin{matrix}X \text{?} + ( L + \text{?} \cdot v \text{?} \cdot L ) \cdot cos ( ψ \text{?} ) + \frac{{W}_{t}}{2} \cdot sin ( ψ \text{?} ) \\ Y \text{?} + ( L + \text{?} \cdot v \text{?} \cdot L ) \cdot sin ( ψ \text{?} ) - \frac{{W}_{t}}{2} \cdot cos ( ψ \text{?} )\end{matrix} ) \qquad [ Equation 15 ]$$

$$\text{?} \text{indicates text missing or illegible when filed}$$

That is, referring to Equations 14 and 15, based on the speed weighting w3 imparted depending on the type of the target 2 and the final weighting w4 in which the weighting w3 is changed depending on the position of the vehicle 1, the controller 200 may expand the danger range 2a based on the speed Vt of the target 2. Accordingly, the danger range 2a of the target 2 may secure a wider area in a moving direction of the target 2 than the size area of the target 2.

As described above, the controller 200 may calculate the danger range 1a of the vehicle 1 and the danger range 2a of the target 2, and may determine the danger of collision based on the danger ranges 1a and 2a. More specifically, the controller 200 may determine the danger of collision depending on a size of an area where the danger range 1a of the vehicle 1 and the danger range 2a of the target 2 overlap. Also, the controller 200 may divide control actions depending on a size of an overlapping area, and may generate a control signal for controlling the driving apparatus 500 based on the divided control actions.

In summary, when the size of the overlapping area between the danger ranges 1a and 2a corresponds to a first area section (a case where the size of the overlapping area is smaller than n1), the controller 200 may provide a warning and/or a notification to the driver by generating a control signal for controlling the display device and/or the audio device of the driving apparatus 500. Also, when the size of the overlapping area between the danger ranges 1a and 2a corresponds to a second area section (a case where the size of the overlapping area is larger than or equal to n1 and smaller than n2), the controller 200 control the longitudinal speed of the vehicle 1 to be equal to or lower than a longitudinal speed of the target 2 by generating a control signal for controlling the braking device and the driving device of the driving apparatus 500. However, the disclosure is not limited thereto. The longitudinal speed of the vehicle 1 may mean, for example, a speed component parallel to the driving direction of the vehicle 1.

Also, when the size of the overlapping area between the danger ranges I a and 2a corresponds to a third area section (a case where the size of the overlapping area is larger than or equal to n3), the controller 200 may reduce the speed of the vehicle 1 by generating a control signal for controlling the braking device of the driving apparatus 500. However, the disclosure is not limited thereto. The preset values n1 to n3 of the overlapping areas between the first to third area sections described above may be experimentally or empirically changed.

As another embodiment, the controller 200 may generate a control signal for controlling the driving apparatus 500 so that the danger range 1a of the vehicle 1 and the danger range 2a of the target 2 do not overlap. More specifically, the controller 200 may identify a free space based on a relative position (distance and direction) and a relative speed of an identified object in front of the vehicle 1. For example, when an object located in a lane adjacent to a driving lane of the vehicle 1 is not identified, the controller 200 may identify both the left and right sides of the vehicle 1 as free spaces. When an object located in front of the right lane of the driving lane of the vehicle 1 is identified, the controller 200 may identify the left side of the vehicle 1 as a free space. However, the disclosure is not limited thereto.

Accordingly, the controller 200 may induce the driver to change the lane of the vehicle 1. The controller 200 may control the display device and/or the audio device to induce a lane change of the vehicle 1. Specifically, the controller 200 may transmit a communication message to the display device and/or the audio device to output an image message and/or a sound message for inducing the driver to perform the lane change of the vehicle 1.

In order to avoid the danger range 1a of the vehicle 1 and the danger range 2a of the target 2 overlapping, the controller 200 may transmit a steering signal for directing to the free space to the steering device. Accordingly, the vehicle 1 may change the lane to a lane of the free space.

The controller 200 may control the display device and/or the audio device to warn the overlap of the danger range 1a of the vehicle 1 and the danger range 2a of the target 2. Specifically, the controller 200 may transmit a communication message to the display device and/or the audio device to output an image message and/or a sound message for warning of overlap between the danger ranges 1a and 2a.

Hereinafter, a method in which the controller 200 of the vehicle 1 according to an embodiment avoids a collision by predicting the expected driving paths of the vehicle 1 and the target 2 and predicting the possibility of collision between the vehicle I and the target 2 will be described in detail.

A person skilled in the art may understand that in determining the danger of collision based on predicting an expected driving path of the vehicle 1 and an expected driving path of the target 2, and a physical collision between the size area of the vehicle 1 and the size area of the target 2, which will be described later, the size area of the vehicle 1 may be replaced with the danger range 1a of the vehicle 1 described above, and the size area of the target 2 may be replaced with the danger range 2a of the target 2 described above.

The controller 200 may determine a first driving direction of the target 2 using at least one of the second sensor devices 300 based on the position of the target 2, determine a second driving direction of the target 2 based on an absolute speed of the target 2 and compare the first driving direction of the target 2 and the second driving direction of the target 2, and may predict a driving direction of the target 2 based on the first driving direction and the second driving direction.

More specifically, the controller 200 predicts the absolute speed of the target 2 and then determines the first driving direction based on the predicted absolute speed. The first driving direction is determined based on the ratio of an absolute lateral speed of the target 2 to an absolute longitudinal speed of the target 2. Thereafter, the second driving direction is determined by selecting at least one of a radar, a lidar, or a camera of the second sensor device 300 depending on the position of the target 2. When there is the target 2 on the front of the vehicle 1, the camera is preferentially selected, otherwise the lateral radar is selected to determine the second driving direction. In this case, detection values of the sensors vary depending on the position of the target 2.

Thereafter, a strategy for deriving a driving direction may be selected by comparing the first driving direction and the second driving direction. Specifically, when a difference between the first driving direction and the second driving direction is much greater than a specific threshold value, it may be determined that it is impossible to predict the driving direction, and when the difference between the first driving direction and the second driving direction is greater than the specific threshold value to an appropriate level, a driving direction derivation strategy may be selected by mixing the first driving direction and the second driving direction in a predetermined ratio, For example, when the camera is selected as a sensor to find the driving direction, because it is advantageous to recognize an inclined shape compared to the radar due to the image recognition characteristics, the specific threshold value for the target 2 in front may be set high. As the difference between the first driving direction and the second driving direction increases, the first driving direction may be determined preferentially. When the difference between the first driving direction and the second driving direction is less than the threshold value, the second driving direction may be determined as the driving direction.

The controller 200 may calculate an offset between the target 2 and the expected driving path based on the expected driving path of the vehicle 1 and the position information of the target 2, determine a point of the predicted driving path closest to the target 2 as a collision point when the offset is less than a first predetermined value, and control the driving apparatus 500 to avoid a collision with the target 2 when a difference between the times at which the vehicle 1 and the target 2 reach the collision point is less than a second predetermined value.

More specifically, the offset between the target 2 and the path of the vehicle 1 is predicted based on the expected driving path of the vehicle 1 and the position of the target 2. After assuming a line drawn in a direction to which the driving direction of the vehicle 1 directs, a difference between a distance from the line to the target 2 and a distance from the line to the expected driving path of the vehicle 1 represents the offset between target 2 and the expected driving path of vehicle 1. In this case, the distance from the line to the expected driving path of the vehicle 1 may be expressed as a product of an angle between the expected driving path of the vehicle and the line and a distance between the vehicle and the target. When the offset between the target 2 and the expected driving path of the vehicle 1 is less than the first predetermined value, it may be predicted that the vehicle and the target collide. The collision point refers to a point where a collision with the target is predicted in the expected driving path of the vehicle. When a difference between the time for arriving the vehicle 1 to the collision point and the time for arriving the target 2 to the collision point is calculated, and the difference value is less than a predetermined value, the controller 200 may determine that the vehicle 1 and the target 2 will collide and control the driving apparatus 500 of the vehicle 1.

Specifically, a distance between the line drawn in the direction to which the driving direction directs and the expected driving path of the vehicle may be calculated by obtaining an angle between the line drawn in the direction to which the vehicle driving direction directs and a point expected to be the collision point of the expected driving path of the vehicle 1 and multiplying the angle by the distance from the vehicle to the target. A distance from a line drawn in a direction to which the vehicle 1 directs to the target 2 may be determined based on the distance between the vehicle 1 and the target 2 and an angle between the line drawn in the direction to which the driving direction directs and the target 2. The distance between the line and the target 2 may be obtained by multiplying the distance between the vehicle 1 and the target 2 by a sine value, and an angle entering the sine value means the angle between the target and the line drawn in the direction to which the driving direction of the vehicle 1 directs based on vehicle 1. Herein, the angle between the line and the point expected to be the collision point may represent a half value of an angle 27 formed between a line passing through the target 2 and a line passing from the vehicle 1 from the line drawn in the direction to which the driving direction of the vehicle 1 directs. As will be described later, when the offset value is maintained constant, it may be determined that the offset between the expected driving path of the vehicle 1 and the target 2 is maintained constant.

In this case, a variable filter in which a signal of the vehicle 1 is input may be applied to the distance between the target 2 and the expected driving path of the vehicle 1.

The surrounding road information of the vehicle 1 obtained from the second sensor device 300 may include information on the opposite side lanes of the vehicle 1, the controller 200 may calculate the offset from the left lane Lh or the right Rh lane of the information on the opposite side lanes to the target 2, determine a point closest to the target 2 on the left lane Lh or the right Rh lane of the information on the opposite side lanes as a second collision point when the offset is less than the first predetermined value, and control the driving apparatus 500 to avoid a collision with the target 2 when the difference between the times at which the vehicle 1 and the target 2 reach the second collision point is less than the second predetermined value,

Specifically, the information on the opposite side lanes of the vehicle 1 may be obtained from the second sensor device 300, and the offset from the left lane Lh or the right lane Rh of the opposite side lanes to the target 2 may be calculated. For example, when the target 2 is located on the right side of the right lane of vehicle 1, an offset between a specific point on the right lane and the target 2 may be obtained by calculating an offset between the right lane and the target 2. When the target 2 is located on the left side of the left lane of vehicle 1, an offset between the left lane and the target 2 may be obtained. After the offset between the left lane and the target 2 is obtained, when the offset is less than the first predetermined value, the point closest to target 2 on the left lane Lh or the right Rh lane of the information on the opposite side lanes is determined as the second collision point. In this case, when the difference between the times at which the vehicle 1 and the target 2 reach the second collision point is less than the second predetermined value, a collision with the target 2 may be controlled to be avoided.

The controller 200 may determine a weighting related to the absolute longitudinal speed of the target 2 depending on the position of the target 2, and may determine a longitudinal movement direction of the target 2 based on the absolute speed of the target 2 obtained from a predetermined previous time point and the absolute speed and weighting of the target 2 at the current time point.

More specifically, the controller 200 may determine the weighting related to the absolute longitudinal speed of the target 2 depending on the position of the target 2. For example, as the angle between the target 2 and the vehicle 1 increases, the recognition ability of the sensor may decrease. In this case, it is necessary to determine a range for a forward movement determination area by setting a high weighting for accurate determination. When the angle between the target 2 and the vehicle 1 increases, the weighting is set high and the threshold value increases, and the absolute longitudinal speed of the target 2 needs to be measured high as the threshold value increases, thereby determining that the vehicle 1 is moving forward. Herein, the threshold value corresponds to a reference value for determining whether the target corresponds to a forward movement or a counter movement based on the weighting value. In this case, because a counter movement determination area is generally generated to be wide, it is generally determined to be the counter movement traveling in the opposite direction to the vehicle 1 regardless of the angle between the vehicle 1 and the target 2. Hysteresis (concept of age) is used to determine whether it is the forward movement or counter movement. For example, when a relative speed of the target 2 traveling in the opposite direction to the vehicle 1 is measured as -100 at a predetermined time point, the target 2 makes a U-turn after a certain period of time and travels at the absolute speed of +10, and the vehicle 1 travels at an absolute speed of +120, the absolute speed of the target 2 calculated by the vehicle 1 becomes −110. Even though the vehicle 1 and the target 2 are currently moving in the same direction (forward movement), when it is determined only by numerical values, it may be determined that t the vehicle 1 and the target 2 are still moving in the opposite direction (counter movement), but this may be overcome using the concept of hysteresis. The hysteresis means a hysteresis phenomenon, and refers to predicting the state of a specific time point by looking at a previous phenomenon based on the specific time point. That is, it may be identified that the speed is reduced by observing a speed change of the target 2 for a predetermined time based on information obtained from a predetermined previous time point and information of the current time point, and it may be predicted that the direction of the target 2 is changed by observing a gradual change in speed.

By making the absolute longitudinal speed of the target 2 as a vertical axis and the angle between the target 2 and the vehicle 1 as a horizontal axis, the angle formed with the vehicle 1 is obtained depending on the position of the target 2, and by obtaining the absolute longitudinal speed of the target, based on the information from the predetermined previous time point and the absolute speed and weighting of the target at the current time point, it is determined whether it corresponds to a forward movement determination area 42 or the counter movement determination area.

The controller 200 may calculate the reference value based on the absolute lateral speed of the target 2 and the driving direction of the target 2, and when the reference value is equal to or greater than a third predetermined value, may determine that the target 2 moves in a transverse direction based on the absolute speed of the target 2 obtained from the predetermined previous time point, the absolute speed of the target 2 at the current time point, and the information obtained from the first sensor device 100.

Specifically, the reference value is determined based on the absolute speed in the lateral direction and the driving direction of the target 2. When the corresponding reference value is equal to or greater than the third predetermined value, it may be determined that the target 2 may move in the lateral direction. In this case, when the reference value is equal to or less than the third predetermined value, the traversal movement may be inaccurately determined. When the reference value is equal to or greater than the third predetermined value, it may be determined whether of the traversal movement using the concept of hysteresis. It is determined whether of the traversal movement based on the absolute speed of the target 2 obtained from the predetermined previous time point, the absolute speed of the target 2 at the current time point, and the driving information of the vehicle For example, because the angle between the target 2 and the vehicle 1 changes greatly with time when the vehicle 1 turns, the determination of the traversal movement is meaningless, and because when the vehicle 1 makes a large turn from the predetermined previous time point, the angle formed with the target 2 continues to change and the speed also changes, it may not be determined that target 2 is moving in the lateral direction. When the speed is greater than the absolute longitudinal speed multiplied by a certain ratio and there is no sudden movement of the vehicle 1 and the path of the vehicle 1 is predicted to be straight forward, the traversal movement may be predicted. In this case, the reference value is finally determined by comparing it with the threshold value.

There is also the target 2, which is inaccurate but may be determined to be in the traversal movement. A reference value for the inaccurate traversal movement determination is calculated based on the predicted absolute longitudinal/transverse speeds, and this is determined by applying the concept of hysteresis.

The controller 200 may calculate an amount of change in the driving direction of the target 2, calculate an amount of change in the heading of the target obtained from the predetermined previous time point, and determine whether the target 2 maintains the driving direction based on the amount of change in the driving direction of the target 2 and the amount of change in the heading of the target obtained from the predetermined previous time point.

The cont oiler 200 may determine an offset between vehicles moving forward in the same direction as the vehicle 1 and the expected driving path of the vehicle 1, and when an offset between the vehicles moving forward in the same direction as the expected driving path of the vehicle 1 is constant, may determine that the offset with the expected driving path of the vehicle 1 is maintained constant. The controller 200 may determine an offset between vehicles moving in the opposite direction to the vehicle 1 and the expected driving path of the vehicle 1, and when an offset between the vehicles moving in the opposite direction to the expected driving path of the vehicle 1 is constant, may determine that the offset with the expected driving path of the vehicle 1 is maintained constant.

When it is determined whether an offset is maintained, the concept of hysteresis may likewise be used. That is, when an interval between vehicles from the predetermined previous time point to the present and the expected driving path of the vehicle 1 is constant with an error less than a predetermined value, it may be determined that the offset is maintained.

In this case, in a method of determining whether the offset is maintained, the amount of change in the offset with the expected driving path of the vehicle 1 needs to be equal to or less than a specific threshold value, the recognized target 2 needs to be within a specific range, and when the position of the target 2 is too far away, a predicted accuracy may be lowered and it may be a meaningless determination for a system. The predicted driving path of the vehicle 1 should not be predicted to be too large a turn. The angle between the target 2 and the vehicle 1 changes significantly with time while the vehicle 1 is turning, so that due to the limited performance characteristics of the camera and radar, it is difficult to guarantee the reliability of the calculation of the amount of change in the offset with the expected driving path of the vehicle 1.

After position information of vehicles moving in the same direction as the vehicle 1 is obtained, parallelism of the left and right lanes may be determined based on the vehicle 1 (similarity of coefficients of cubic equations of the recognized opposite side lanes of the vehicle 1 may be compared). When conditions of an amount of change in curvature (3rd term), a curvature (2nd term), a lane slope at a starting position (1st term), and determination of parallelism of the opposite side lanes of the vehicle 1 are satisfied, lanes may be virtually created using a method of adding as much as the width of the lane at the current location (The prediction of the lane width is determined based on an offset between the left lane Lh or right lane Rh and the vehicle 1 at the starting position.). Finally, by comparing a predicted offset value with the opposite side lanes of the vehicle 1 with the estimated result, it may be estimated in which lane the target 2 is located. In the method of determining whether the offset between the opposite side lanes of the vehicle 1 and the target 2 is maintained, a corrected offset value between the left and right lanes of the target 2 needs to be equal to or less than the specific threshold value, the amount of change in the offset between the left lane Lh or the right Rh lane of the opposite side lanes of the vehicle 1 and the target 2 needs to be greater than or equal to the specific threshold value, and the lane width may be greater than or equal to a specific percentage of a vehicle width of the object. For the calculation method, the method of hysteresis may be used similarly.

As a result, it may be determined whether the offset between the opposite side lanes of the vehicle 1 and the target 2 is maintained.

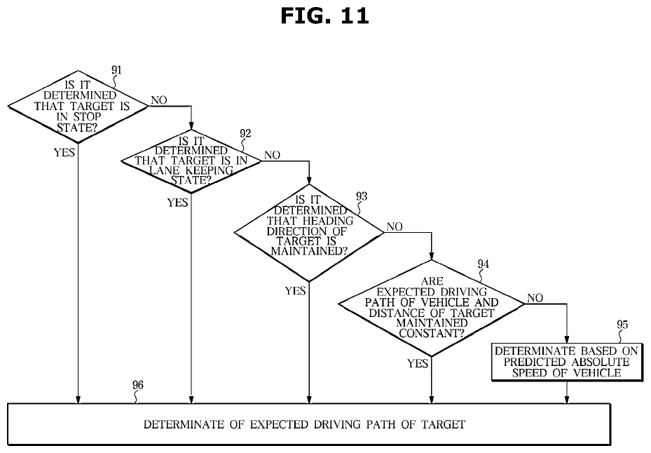

FIG. 11 is a diagram illustrating an example of an operation of determining an expected driving path of a target by giving priority to determining a driving state of the target.

Referring to FIG. 11, the surrounding road information of the vehicle 1 includes information on the opposite side lanes of the vehicle 1, the controller 200 may predict the offset between the target and the expected driving path based on the expected driving path of the vehicle and the position information of the target, determine whether the offset between the target and the expected driving path of the vehicle is maintained constant based on the amount of change in the offset between the target obtained from the predetermined previous time point and the expected driving path of the vehicle and the amount of change in the offset between the target at the current time point and the expected driving path of the vehicle, calculate the amount of change in the driving direction of the target 2, determine whether the target 2 is maintaining the driving direction based on the amount of change in the driving direction of the target 2 and the amount of change in the heading of the target 2 obtained from the predetermined previous time point, determine the state in which the offset from the left lane Lh or the right lane Rh of the information on the opposite side lanes to the target 2 is maintained constant as the first state, determine the state in which the driving direction of the target 2 is maintained as the second state, determine the state in which the offset between the expected driving path of the vehicle 1 and the target 2 is maintained constant as the third state, determine a state in which the target 2 is stopped as the fourth state, determine a state in which the target 2 travels linearly as the fifth state, prioritize the first to fifth states, and predict the expected driving path of the target 2 based on the priority.

A tangible state is a state including the first to third states, may include all of the first to fifth states, may mean a specific driving state, such as a state of maintaining an offset between the target and the vehicle.

Referring to FIG. 11, whether the target 2 may be determined to be in a stop state is determined preferentially (91), the reliability of the expected driving path of the vehicle 1 may be compared with the predetermined threshold value (In this case, the threshold value may be different for each state of the target 2) when it is determined that the target 2 is in the stop state, the expected driving path of the target 2 may be determined (96) when the reliability of the expected driving path of the vehicle 1 is equal to or greater than the predetermined threshold value, it may be determined whether the target 2 is in a lane keeping state (92) when it is not determined that the target 2 is in the stop state (91), and the reliability of the expected driving path of the vehicle 1 and the predetermined threshold value may be compared when the target 2 is determined to be in the lane keeping state (92). When the reliability of the expected driving path of the vehicle 1 is greater than the predetermined threshold value, the expected driving path of the target 2 may be determined (96), and otherwise, it may be determined whether the driving direction of the target 2 is maintained (93). In a case where the driving direction of target 2 is maintained (93), when the reliability of the expected driving path of the vehicle 1 is greater than the predetermined threshold value, the expected driving path of the target 2 may be determined (96), and otherwise, it may be determined whether the offset between the expected driving path of the vehicle 1 and the target 2 is maintained constant. In the same manner, it may be determined whether the offset between the expected driving path of the vehicle 1 and the target 2 is maintained constant, the reliability of the expected driving path of the vehicle 1 and the predetermined threshold value may be compared when the offset between the expected driving path of the vehicle 1 and the target 2 is maintained constant (94), the expected driving path of the target 2 may be determined when the reliability is greater than or equal to the threshold value, and the expected driving path of the target 2 may be determined based on the predicted absolute speed of the vehicle 1 (95) when the reliability is equal to or less than the threshold value. When the predicted driving path of the target 2 is determined based on the predicted absolute speed of vehicle 1 (95), the reliability of the expected driving path of the vehicle 1 and the threshold value may not be compared.

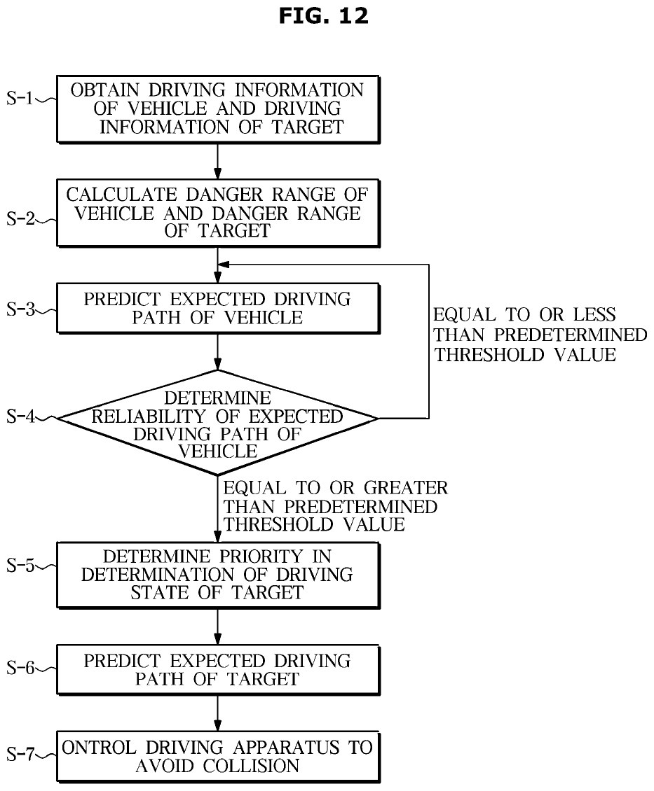

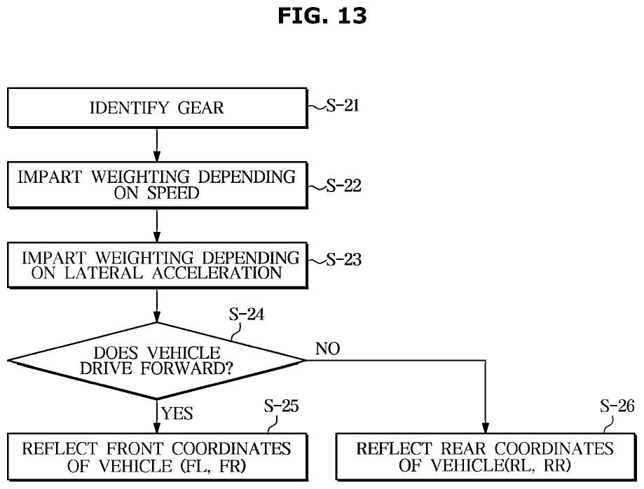

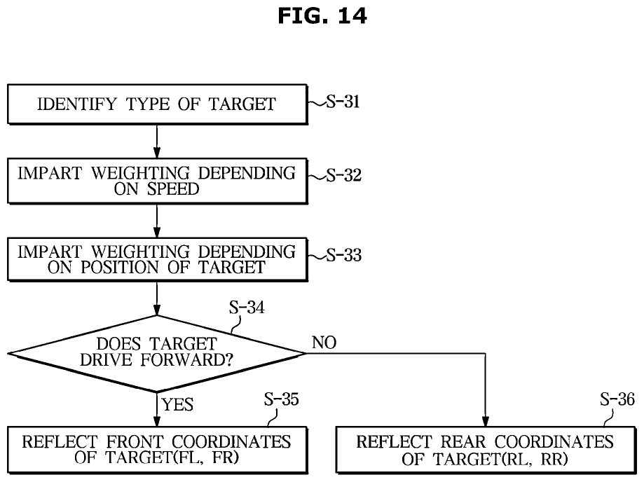

FIG. 12 is a flowchart illustrating a vehicle control method according to an embodiment. FIG. 13 is a flowchart illustrating a method of calculating the danger range of the vehicle according to an embodiment. FIG. 14 is a flowchart illustrating a method of calculating a danger range of a target according to an embodiment.

The vehicle control method illustrated in FIGS. 12 to 14 may be performed by the vehicle 1 described above. Therefore, although not described below, the contents described above for the vehicle 1 may be equally applied to the vehicle control method.

Referring to FIG. 12, the vehicle 1 may obtain the driving data of the vehicle 1 by the first sensor device 100 installed in the vehicle 1 (S-1).

Also, the vehicle 1 may obtain the surrounding data of the vehicle 1 by the second sensor device 300 installed in the vehicle 1 (S-1).

The vehicle 1 may identify the target 2 around the vehicle 1 based on the processing of the surrounding data, and may calculate the danger range 2a of the identified target 2 (S-2).

Also, the vehicle 1 may calculate the danger range 1a of the vehicle 1 based on the processing of the driving data (S-2).

The vehicle 1 may predict the expected driving path of the vehicle 1 based on the GPS data of the vehicle 1 and the driving information of the vehicle 1 (S-3), and may determine the prediction reliability of the expected driving path of the vehicle 1 (S-4). The reliability may be determined based on the GPS data of the vehicle and the expected driving path of the vehicle in the manner described above.

The vehicle 1 may predict the expected driving path of the vehicle 1 again when the reliability is equal to or less than the predetermined threshold value, and may determine a priority in the determination of the driving state of the target 2 when the reliability is greater than or equal to a predetermined value (S-5).

The vehicle 1 may predict the expected driving path of the target 2 based on the priority (S-6), determine the danger of collision based on the expected driving path of the vehicle 1, the expected driving path of the target 2, the danger range 1a of the vehicle 1, and the danger range 2a of the target 2, and control the driving apparatus 500 to avoid a collision based on the danger of collision (S-7).

Referring to FIG. 13, the vehicle 1 may identify the gear of the vehicle 1 (S-21). Depending on the gear of the vehicle 1, as described above, the vehicle 1 may differently impart the weighting w1 depending on the speed of the vehicle 1 and the weighting w2 depending on the lateral acceleration.

The vehicle 1 may impart the weighting w1 based on the speed Vs of the vehicle 1 (S-22). Also, the vehicle 1 may impart the weighting w2 based on the lateral acceleration ρ of the vehicle 1 (S-23).

When the driving direction of the vehicle 1 directs to the front of the vehicle 1 depending on the gear of the vehicle 1, the vehicle 1 may reflect the weightings w1 and w2 to the front coordinates 71 and 72 of the vehicle 1 (S-24 and S-25). Also, when the driving direction of the vehicle 1 directs to the rear of the vehicle 1 depending on the gear of the vehicle 1, the vehicle 1 may reflect the weightings w1 and w2 to the rear coordinates 73 and 74 of the vehicle 1 (S-24 and S-26). In summary, when the weighting in step S-25 and the weighting in step S-26 are compared, the weightings w1 and w2 reflected in step S-26 may be greater than those in step S-25.

Referring to FIG. 14, the vehicle 1 may identify the type of the target 2 (S-31). Depending on the type of the target 2, as described above, the vehicle 1 may impart the weighting w3 differently depending on the speed.

The vehicle 1 may impart the weighting w3 based on the speed Vt of the target 2 (S-32). Also, the vehicle 1 may impart the final weighting w4 based on the position of the target 2 (S-33).

When the target 2 travels in front of the target 2 depending on the driving direction of the target 2, the vehicle 1 may reflect the final weighting w4 to the front coordinates 102 and 103 of the target 2 (S-34 and S-35). Also, when the target 2 travels in the rear of the target 2, the vehicle 1 may reflect the final weighting w4 to the rear coordinates of the target 2 (S-34 and S-36).

Herein, the disclosed embodiments may be implemented in the form of a recording medium storing instructions executable by a computer. The instructions may be stored in the form of program code, and when executed by a processor, a program module may be created to perform the operations of the disclosed embodiments. The recording medium may be implemented as a computer-readable recording medium.

The computer-readable recording medium includes various kinds of recording media in which instructions which may be decrypted by a computer are stored. For example, there may be a ROM (read only memory), a RAM (random access memory), a magnetic tape, a magnetic disk, a flash memory, an optical data storage device, and the like.

As is apparent from the above, a vehicle and a control method thereof according to an embodiment can avoid a collision based on a danger range by calculating the danger range between the vehicle and a surrounding object of the vehicle depending on a factor causing uneasiness of a user.

The embodiments disclosed with reference to the accompanying drawings have been described above. However, it will be understood by those skilled in the art that various changes in form and details may be made therein without departing from the spirit and scope of the disclosure as defined by the appended claims. The disclosed embodiments are illustrative and should not be construed as limiting.

What is claimed is:

1. A vehicle comprising:
a first sensor device installed in the vehicle to obtain driving data of the vehicle;
a second sensor device installed in the vehicle to obtain surrounding data of the vehicle;
a driving apparatus configured to control a driving direction and speed of the vehicle; and
a controller comprising a processor configured to process the surrounding data and the driving data,
wherein the controller is configured to:
identify a target around the vehicle and calculate a danger range of the identified target, based on processing the surrounding data,
calculate a danger range of the vehicle based on processing the driving data,
determine a danger of collision based on the danger range of the target and the danger range of the vehicle, and
control the driving apparatus based on the determined danger of collision.

2. The vehicle according to claim 1, wherein
the danger range of the target is different from a size of the target, and the danger range of the vehicle is different from a size of the vehicle.

3. The vehicle according to claim 2, wherein
the controller is further configured to:
predict an expected driving path of the vehicle and an expected driving path of the target based on processing the driving data and the surrounding data, and
determine the danger of collision further based on the expected driving path of the vehicle and the expected driving path of the target.

4. The vehicle according to claim 3, wherein the controller is further configured to:
determine reliability of the expected driving path of the vehicle based on a learning table generated by pre-learning based on the expected driving path of the vehicle and the driving data of the vehicle,
determine the expected travel path of the target in response to a case where the reliability is greater than or equal to a predetermined threshold value, and
control the driving apparatus such that the danger range of the vehicle and the danger range of the target do not overlap.

5. The vehicle according to claim 2, wherein
the danger range of the vehicle is calculated based on at least one of a position, size, gear, driving direction, speed, or lateral acceleration of the vehicle.

6. The vehicle according to claim 5, wherein
the controller is further configured to:
impart a weighting to at least one of the gear, speed, or lateral acceleration of the vehicle, and
expand the danger range of the vehicle further based on the weighting.

7. The vehicle according to claim 2, wherein
the danger range of the target is calculated based on at least one of a type, position, size, speed, or driving direction of the target.

8. The vehicle according to claim 7, wherein
the controller is further configured to:
impart a weighting to at least one of the speed or the position depending on the type of the target, and
expand the danger range of the target further based on the weighting.

9. The vehicle according to claim 2, wherein
the controller is further configured to:
divide control actions depending on a size of an area in which the danger range of the target and the danger range of the vehicle overlap, and
control the driving apparatus based on the divided control actions.

10. A control method of a vehicle comprising:
obtaining driving data of the vehicle by a first sensor device installed in the vehicle;
obtaining surrounding data of the vehicle by a second sensor device installed in the vehicle;
identifying a target around the vehicle and calculating a danger range of the identified target, based on processing the surrounding data;
calculating a danger range of the vehicle based on processing the driving data;
determining a danger of collision based on the danger range of the target and the danger range of the vehicle; and
controlling a driving apparatus based on the determined danger of collision.

11. The control method according to claim 10, wherein
the danger range of the target is different from a size of the target, and the danger range of the vehicle is different from a size of the vehicle.

12. The control method according to claim 11, further comprising
predicting an expected driving path of the vehicle and an expected driving path of the target based on processing the driving data and the surrounding data,
wherein the controlling of the driving apparatus comprises determining the danger of collision further based on the expected driving path of the vehicle and the expected driving path of the target.

13. The control method according to claim 12, wherein
the predicting of the paths comprises
determining reliability of the expected driving path of the vehicle based on a learning table generated by pre-learning based on the expected driving path of the vehicle and the driving data of the vehicle, and
determining the expected travel path of the target in response to a case where the reliability is greater than or equal to a predetermined threshold value, and
wherein the controlling of the driving apparatus comprises controlling the driving apparatus such that the danger range of the vehicle and the danger range of the target do not overlap.

14. The control method according to claim 11, wherein
the danger range of the vehicle is calculated based on at least one of a position, size, gear, driving direction, speed, or lateral acceleration of the vehicle.

15. The control method according to claim 14, further comprising:
imparting a weighting to at least one of the gear, speed, or lateral acceleration of the vehicle; and
expanding the danger range of the vehicle further based on the weighting.

16. The control method according to claim 11, wherein
the danger range of the target is calculated based on at least one of a type, position, size, speed, or driving direction of the target.

17. The control method according to claim 16, further comprising
imparting a weighting to at least one of the speed or the position depending on the type of the target; and
expanding the danger range of the target further based on the weighting.

18. The control method according to claim 11, wherein
the controlling of the driving apparatus comprises
dividing control actions depending on a size of an area in which the danger range of the target and the danger range of the vehicle overlap, and
controlling the driving apparatus based on the divided control actions.

19. A computer-readable recording medium in which a program capable of executing the control method of the vehicle according to claim 10 is recorded.
